(19) United States
(12) Patent Application Publication
(10) Pub. No.: US 2011/0289927 A1
(43) Pub. Date: Dec. 1, 2011

(54) Method for Flushing a Section of a Fuel System of a Gas Turbine

(76) Inventor: Ulrich Wagner, Engelskirchen (DE)

(21) Appl. No.: 13/148,199

(22) PCT Filed: Jan. 22, 2010
(86) PCT No.: PCT/EP2010/050708

§ 371 Date: Aug. 5, 2011

(30) Foreign Application Priority Data
Feb. 6, 2009 (EP) 09001717.9

(51) Int. Cl. F02C 7/232; B08B 3/00; B08B 5/04

(52) U.S. Cl. 60/734; 137/15.05; 134/21

(57) ABSTRACT

A fuel system of a burner of a gas turbine and to a method for flushing a section of a fuel system of a burner of a gas turbine is provided. The method includes providing a feed line for feeding liquid fuel from a fuel source to the burner, providing a first and a second connection point to the feed line, providing a medium at the first connection point and generating a vacuum at the second connection point such that the fuel which is situated in the section between the two connection points is sucked out through the second connection point.

### CROSS REFERENCE TO RELATED APPLICATIONS

This application is the US National Stage of International Application No. PCT/EP2010/050708, filed Jan. 22, 2010 and claims the benefit thereof. The International Application claims the benefits of European Patent Office application No. 09001717.9 EP filed Feb. 6, 2009. All of the applications are incorporated by reference herein in their entirety.

### FIELD OF INVENTION

The invention relates to a method for flushing a section of a fuel system of a burner of a gas turbine. The invention relates, furthermore, to a fuel system of a burner of a gas turbine with a supply line for supplying fuel from a fuel source to the burner.

### BACKGROUND OF INVENTION

In gas turbines operating with fuel oil, the fuel oil or liquid fuel has to be removed, after operation, from the burners and from the delivery pipelines connected to them, in order to prevent carbonization of the fuel oil on their hot surfaces. Carbonization would block lines and burners and therefore make them useless. When the fuel oil is being removed, what is known as the flushing of the supply line for the supply of fuel, no further fuel oil should enter the combustion chamber of the burner because this could lead to detonations and further damage.

EP 0 939 220 A1 discloses a method in which the burners and delivery lines of gas turbines are flushed in order thereby to remove the fuel oil from the lines or from the burner. For this purpose, water is forced via a water line of an NOx water supply system (which is present in any case for fuel oil/water emulsion operation) into the fuel oil line and thereafter into the combustion chamber. Fuel oil is thereby emptied from the burner and a line piece. In a second step, the water of the NOx water supply system is forced into the fuel oil line such that it forces the fuel oil contained in the fuel oil line backward in the direction of the fuel oil delivery (fuel oil/water injection package), from where it is introduced via open valves into an emptying system. In the flushing method of this type and the associated fuel system, residues may remain in the fuel oil line under specific operating conditions.

Furthermore, a further fuel line system for a gas turbine is known from JP-A-01-294916. To prevent damage to valve components on account of thermal expansions of the line system, according to the method air provided by a compressor is routed to the combustion chamber of the gas turbine via bypass lines. Compressor air is in this case delivered while line flushing in the fuel line is being terminated.

Furthermore, EP 1 944 485 A2 discloses a fuel feed pump which, by its direction of rotation being reversed, can suck away the fuel present in a line section leading to a burner.

### SUMMARY OF INVENTION

An object of the invention is to provide a method for flushing a section of a fuel system of a burner of a gas turbine and also an associated fuel system, in which the abovementioned disadvantages are overcome and, in particular, during flushing, with a high degree of certainty no further fuel enters the combustion chamber of the burner.

The object is achieved according to the invention by means of a method for flushing a section of a fuel system of a burner of a gas turbine for liquid fuels according to the claims and by means of a fuel system of a burner of a gas turbine according to the claims. Advantageous developments of the solution according to the invention are described in the dependent claims.

According to the invention, a method for flushing a section of a fuel system of a burner of a gas turbine, having the following steps, is provided: provision of a supply line for supplying liquid fuel from a fuel source to the burner, provision of a first and a second connection point on the supply line, provision of a liquid medium at the first connection point, and generation of a vacuum at the second connection point for sucking away the liquid fuel contained in the section between the two connection points through the second connection point, the fuel being sucked away causing the medium to be sucked in at the first connection point for flushing the section.

The method of this type overcomes the actual problem of known procedures which cannot ensure that fuel oil is forced into the burner or burners during flushing. The problem is overcome in that the flushing pressure in the burner system lies reliably below the ambient pressure and therefore also reliably below the pressure prevailing in the burner chamber of an assigned burner. This is achieved in that a vacuum is generated at the second connection point on the supply line near the discharge system. The vacuum sucks the fuel out of the line section. At the same time, without air being drawn in, the fuel sucks the medium at the first connection point into the supply line until this, too, after it has displaced the fuel completely, emerges at the second connection point. The section is thereby freed of fuel completely. During this flushing of the supply line, that fuel which may possibly still be contained in the line section between the combustion chamber and the second connection point can also be sucked into the discharge system.

In the method according to the invention, the first connection point is provided remotely from the burner and the second connection point near the burner on the supply line. By means of this procedure, during flushing, the liquid fuel is conveyed over the longest section of the supply line in the direction of the burner. The supply line is therefore flushed through in the same direction as the liquid fuel also flows in it. The advantage of this is that, for example, joints and junction points present for structural reasons in the supply line are flushed more cleanly. Of course, it is also conceivable for the supply line to be flushed in the opposite direction.

In a second advantageous development of the method according to the invention, the vacuum is generated at the second connection point by means of a suction or scavenging pump arranged in a drainage line. Since corresponding drainage lines are present in any case in known fuel systems, only a pump has to be inserted into an existing line for the purpose of this development. This not only has cost benefits in terms of plants newly to be installed, but also entails the advantage that the solution can be integrated simply and cost-effectively even in existing gas turbines.

In a third advantageous development of the method according to the invention, the medium is provided at the first connection point by means of a reservoir in which the pressure of the medium is maintained, in particular, at ambient pressure. The reservoir of this type may be configured cost-effectively in the manner of a tub or (open) tank and, in particular, does not have to have any pressure sealing. The reservoir should be arranged in a line which runs parallel to a delivery line of a water injection system with an injection pump arranged in it. The reservoir is then connected in parallel to said injection pump. Thus, selectively, the path through the injection pump (for the injection of medium, in particular water, for fuel oil/water emulsion operation) or the path through the reservoir (for the pressureless feed of medium during the flushing operation) can be set by means of a simple changeover valve.

In a fourth advantageous development of the method according to the invention, the medium used is water because of the abovementioned advantages. As mentioned, water is already present in gas turbines in the NOx water supply system there, by means of which, when the gas turbine is in operation, the water can be metered into the burner in order to reduce the emission of nitrogen oxides.

The solution according to the invention provides, furthermore, a fuel system of a burner of a gas turbine, with a supply line for supplying fuel from a fuel source to the burner, a first and a second connection point on the supply line, a means for the provision of medium at the first connection point, and a means for generating a vacuum at the second connection point and for sucking away the fuel contained in the section between the two connection points through the second connection point.

In a first advantageous development of the fuel system according to the invention, the first connection point is provided remotely from the burner and the second connection point near the burner on the supply line.

In a second advantageous development of the fuel system according to the invention, the means for generating a vacuum at the second connection point is configured with a scavenging pump arranged in a drainage line.

In a third advantageous development of the fuel system according to the invention, the means for the provision of medium at the first connection point is configured with a reservoir in which the pressure of the medium is maintained, in particular, at ambient pressure.

In a fourth advantageous development of the fuel system according to the invention, the medium is formed by water.

Furthermore, a multifunction actuating member with the following switching positions is advantageously provided in the fuel system at the connection point remote from the burner:
Switching position 1: Junction of the supply of medium to the near-burner connection point, junction of the supply of fuel to the connection point remote from the burner, closing of the drainage line (normal combustion operation);
Switching position 2: Junction of the supply of medium to the connection point remote from the burner and junction of the near-burner connection point to the drainage line (flushing with vacuum); and/or
Switching point 3: Closing of the supply of medium to the near-burner connection point, closing of the supply of medium to the connection point remote from the burner, junction of the supply of fuel to the drainage line (discharge of residual fuel).

During normal combustion operation, medium can advantageously be fed in under pressure via the near-burner connection point by means of the multifunction valve. Furthermore, if appropriate, the nozzles on the burner can be flushed into the combustion chamber of the latter via the near-burner connection point. Furthermore, medium can be supplied pressurelessly via the connection point remote from the burner and sucked away into the drainage (as explained above). The multifunction actuating member of this type can be manufactured and also tested as a unit. Furthermore, it can be activated within the fuel system by means of only one line bundle, that is to say, overall, especially cost-effectively. Moreover, when the burner is operating normally, its actuating members shut off the fuel supply line with respect to the feed of extraneous medium.

The solution according to the invention thus makes it possible, overall, to have simple, cost-effective and at the same time especially effectively cleaning flushing of the supply line for fuel on a gas turbine.

### BRIEF DESCRIPTION OF THE DRAWINGS

An exemplary embodiment of the solution according to the invention is explained in more detail below by means of the accompanying diagrammatic drawing. The FIGURE shows a basic diagram of an exemplary embodiment of a fuel system of a gas turbine according to the invention.

### DETAILED DESCRIPTION OF INVENTION

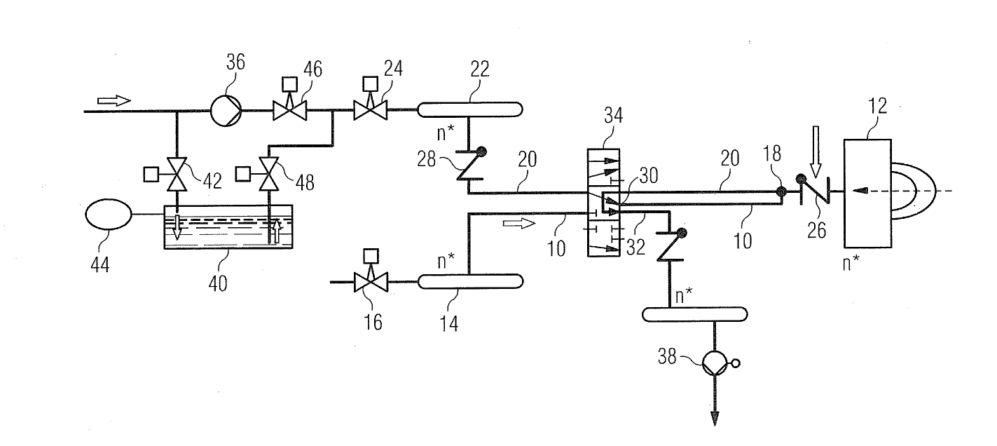

FIG. 1 illustrates a fuel system with a supply line 10 for supplying fuel or fuel oil to a burner 12 (a number n of burners 12 being present). The fuel is in this case fed into a fuel oil flow actuator 14 by means of an actuating member in the form of an actuating valve 16, from which it enters the supply line 10.

Formed near the burner 12, in the supply line 10, is a T-piece or connection point 18, at which a medium can be fed into the supply line 10 through a feed line 20. The medium is water which comes from a water distributor 22 of an NOx water supply system with an actuating valve 24 arranged upstream of it in the flow direction. In this case, a nonreturn valve 26 opening toward the burner 12 is provided in the supply line 10 between the connection point 18 and the burner 12 and a nonreturn valve 28 opening toward the connection point 18 is provided in the feed line 20.

Upstream of the connection point 18 in the flow direction is arranged, in the supply line 10, a further connection point 30 at which water can be fed into the supply line 10 from the section, remote from the burner, of the feed line 20. Furthermore, water from the near-burner section of the feed line 20 can be discharged into a drainage or discharge line 32 at the connection point 30. The connection point 30 is in this case configured with a multifunction actuating member 34 which for this purpose changes over between two positions, but, overall, may even assume three positions.

When the fuel system of this type of a gas turbine is operating normally, the multifunction actuating member 34 is in its position, lowermost with respect to the FIGURE, in which the feed line 20 and supply line 10 are set to throughflow, and thus ensures that both fuel and water are injected at the burner 12. In this case, the water from the NOx water supply system is forced via the feed line 20 into the burner 12 by means of an injection pump 36 arranged downstream of the actuating valve 24 in the flow direction.

After the fuel system has been shut down, first the fuel is flushed into the combustion chamber, located between the connection point 18 and the burner 12. This is achieved by the supply of water by the feed line 20.

To flush the lines of the fuel system of this type of a gas turbine, that is to say the supply line 10, the multifunction actuating member 34 switches into the position, illustrated in the FIGURE, in which it joins the section, remote from the burner, of the feed line to the supply line 10 at the connection point 30 and, furthermore, makes a connection between the near-burner section of the feed line 20 and the drainage line 32.

After the multifunction actuating member 34 has been changed over in this way, fuel is sucked away from the drainage line 32 by means of a suction or scavenging pump 38 arranged in the drainage line 32 and thereby sucks in that fuel which is contained in the near-burner section of the supply line 10. At the same time, water is sucked out of the section, remote from the burner, of the feed line 20 into this section of the supply line 10. The water in this case flushes the supply line 10 in the same flow direction as the fuel previously flowed in this line during normal operation.

So that the water always in any event flows in at ambient pressure in the section, remote from the burner, of the feed line 20 and is not forced, for example, by the injection pump 36 into the supply line 10 and consequently possibly even into the burner 12, a reservoir 40 which is under ambient pressure is connected in parallel to the injection pump 36.

The water provided for flushing is therefore maintained under ambient pressure in the reservoir 40. A filling valve 42, which is controlled via level measurement 44, ensures that water from a preceding system (not illustrated in any more detail) having a conveying device there is ready in a sufficient quantity in the reservoir 40. For the flushing operation, the injection pump 36 is then switched off, a stop valve 46 arranged downstream of the latter in the flow direction is closed, an actuating valve 48 leading out of the reservoir 40 is opened and the scavenging pump 38 is started. The water thereupon flows at a pressure lower than ambient pressure from the reservoir 40 through the multifunction actuating member 34 into the supply line 10. The water displaces the fuel oil or fuel there and enters the drainage line 32, without fuel or water being able to be forced into the burner 12.

The invention allows complete flushing of the supply line or supply lines 10 in the normal fuel oil flow direction. Further advantages are reliable removal of the fuel oil from the fuel oil lines even in the event of a low or absent combustion chamber pressure.

1.-8. (canceled)

9. A method for flushing a section of a fuel system of a burner of a gas turbine for liquid fuel, comprising:
providing a supply line for supplying liquid fuel from a fuel source to the burner;
providing a first and a second connection point on the supply line;
providing a liquid medium at the first connection point; and
generating a vacuum at the second connection point for sucking away the liquid fuel contained in the section between the two connection points through the second connection point,
wherein the first connection point is provided remotely from the burner and the second connection point is near the burner on the supply line, and
wherein the liquid fuel being sucked away causes the medium to be sucked in at the first connection point for flushing the respective section between the two connection points.

10. The method as claimed in claim 9, wherein the vacuum is generated at the second connection point by means of a scavenging pump arranged in a drainage line.

11. The method as claimed in claim 9, wherein the medium is provided at the first connection point by means of a reservoir in which a pressure of the medium is maintained, in any event, at ambient pressure.

12. The method as claimed in claim 11, wherein the reservoir is arranged in a line which runs parallel to a delivery line of a water injection system where an injection pump is arranged.

13. The method as claimed in claim 9, wherein the medium used is water.

14. The method as claimed in claim 9, wherein a multifunction actuating member including three switching positions is provided at the first connection point to regulate a fluid flow through a feed line and the supply line.

15. A fuel system of a burner of a gas turbine with a supply line for supplying liquid fuel from a fuel source to the burner, comprising:
a first and a second connection point on the supply line;
a first means for the provision of a medium at the first connection point; and
a second means for generating a vacuum at the second connection point and for sucking away the liquid fuel contained in the section between the two connection points through the second connection point,
wherein the first connection point is provided remotely from the burner and the second connection point is provided near the burner on the supply line.

16. The fuel system as claimed in claim 13, wherein the means for generating a vacuum at the second connection point is configured with a scavenging pump arranged in a drainage line.

17. The fuel system as claimed in claim 15, wherein the first means for the provision of medium at the first connection point is configured with a reservoir in which a pressure of the medium is maintained, in any event, at ambient pressure.

18. The fuel system as claimed in claim 17, wherein the reservoir is arranged in a line which runs parallel to a delivery line of a water injection system where an injection pump is arranged.

19. The fuel system as claimed in claim 15, wherein the medium is formed by water.

20. The fuel system as claimed in claim 15, wherein a multifunction actuating member including three switching positions is provided at the first connection point to regulate a fluid flow through a feed line and the supply line.
